(19) United States
(12) Patent Application Publication
(10) Pub. No.: US 2001/0035071 A1
(43) Pub. Date: Nov. 1, 2001

(54) Dieboard and method of construction

(76) Inventors: John J. Martin, Pewee Valley, KY (US); Regan Wieland, Auburn, MI (US); Bob Williams, Midland, MI (US)

Correspondence Address: RANDALL C BROWN, AKIN GUMP STRAUSS HAUER & FELD, P O BOX 688, DALLAS, TX, 75313

(21) Appl. No.: 09/821,213

(22) Filed: Mar. 29, 2001

Related U.S. Application Data
(60) Provisional application No. 60/195,766, filed on Apr. 10, 2000.

(51) Int. Cl. B26D 1/12

(52) U.S. Cl. 76/107.1; 76/115; 83/13; 83/663

(57) ABSTRACT

A dieboard for diecutting machinery includes a face layer and a backing layer constructed of a resin-impregnated pulp paper sheet material, and a plurality of core layers constructed of a natural wood veneer located between the face and backing layers. The veneer layers adjacent the face and backing layers have a grain direction that is substantially parallel to a longitudinal axis of the dieboard. The layers are then shaped and laminated together to from the dieboard. The resulting dieboard is relatively free of surface defects.

### CROSS REFERENCE TO RELATED APPLICATIONS

This application claims the benefit of U.S. Provisional application Ser. No. 60/195,766 filed on Apr. 10, 2000.

### BACKGROUND OF THE INVENTION

1. Field of the Invention

This invention relates to diecutting machinery, and more particularly to an improved dieboard used in diecutting machinery and a method of constructing the dieboard.

2. Description of the Related Art

Diecutting machinery is typically used for cutting, slitting, scoring, perforating, forming crease lines, and so on, in paper, cardboard, textiles, leather, plastic, circuit boards, and other sheet material. As shown in FIG. 1, a typical diecutting machine 10 includes a semi-cylindrical dieboard 12 that rotates about an axis 16 and a cylindrical anvil 14 that rotates about an axis 18. The conventional dieboard 12 is typically constructed of a cross-laminated wood veneer having several core layers 20 (FIG. 1A), a face layer 22, and a backing layer 24. A pattern 25 of slits is cut through the laminate, typically with a laser cutter. Forming elements such as cutting blades, perforators, creasers, and the like, as well as ejection rubber, are installed in the slits. A sheet material 26 is fed between the anvil 14 and dieboard 12 in a direction as represented by arrow 28 during rotation of the platen and dieboard about their respective axes. The forming elements contact and cut into the sheet material while pressing against the anvil to form the finished sheet product. The anvil is typically covered with a soft urethane blanket to ensure that the cutting elements penetrate completely through the sheet material for a clean cut. Cardboard storage boxes, cereal boxes, greeting cards, perforated coupon sheets, and other products can be formed in this manner.

Although the above-described arrangement is very efficient in forming sheet products, the construction of the dieboard itself is insufficient in retaining industry tolerances and requires time consuming finishing of the face and backing layers. The face layer 22, backing layer 24 and the core layers 20 are typically constructed of a hardwood veneer such as maple. The face layer 22 must be smooth and free of defects since any surface anomaly would increase the difficulty of the diemaker to produce a high quality finished product. However, wood veneers typically include surface defects such as splits, cracks, checks, knot holes, scratches, rough areas, mineral streaks, discoloration, and uneven splicing which must be corrected by hand through finishing techniques such as scraping, filling, sanding, and so on. Such techniques are both labor intensive and time consuming, and contribute to the overall cost of the dieboard. Currently, it is estimated that between 30 and 50 percent of dieboard construction time involves refinishing of the surface layers. Laminate defects may also be magnified during the lamination process. Some dieboards may have surface defects that are beyond repair and therefore must be discarded, resulting in wasted time and materials, as well as increased cost for acceptable dieboards.

Moreover, the grain direction of the face layer 22 extends in a direction 30 between an upper edge 32 and a lower edge 34 of the face layer 22. This grain direction also contributes to surface defects, delamination between layers, as well as splitting and buckling. Such defects may occur during use and propagate to the sheet material being cut, resulting in rejection of both the dieboard and the sheet material, as well as possible damage to processing machinery. Variation in moisture content and thickness of the veneers may also contribute to defective dieboards.

### SUMMARY OF THE INVENTION

It is therefore an object of the invention to provide a dieboard that is relatively free of surface defects with increased dimensional stability over prior art dieboards.

It is a further object of the invention to provide a dieboard that requires little or no hand finishing.

It is an even further object of the invention to provide a method of constructing a dieboard that reduces labor time and material cost over prior art dieboards.

According to an exemplary embodiment of the invention, a dieboard is provided for use in diecutting machinery. The dieboard includes a face layer constructed of a resin-impregnated pulp paper sheet material, a backing layer constructed of one of a natural wood veneer and a resin-impregnated pulp paper sheet material, and a first core layer constructed of a natural wood veneer. The first core layer is interposed between the face layer and the backing layer.

According to a further embodiment of the invention, a method of forming a dieboard for use in diecutting machinery is also provided. The method includes providing a face layer constructed of a resin-impregnated pulp paper sheet material, providing a backing layer constructed of one of a natural wood veneer and a resin-impregnated pulp paper sheet material, providing a first core layer constructed of a natural wood veneer, and laminating the first core layer between the face layer and the backing layer.

Other objects and advantages of the invention will become apparent upon reading the following detailed description and appended claims, and upon reference to the accompanying drawings.

### BRIEF DESCRIPTION OF THE DRAWINGS

The preferred embodiments of the present invention will hereinafter be described in conjunction with the appended drawings, wherein like designations denote like elements, and wherein:

FIG. 1 is an isometric schematic representation of a prior art diecutting machine;

FIG. 1A is an end view of a prior art dieboard;

FIG. 2 is an isometric schematic representation of a dieboard according to the invention;

FIG. 2A is an end view of the dieboard of FIG. 2; and

FIG. 3 is an end view of the dieboard of FIG. 2 together with a mold for shaping the dieboard during a dieboard forming process.

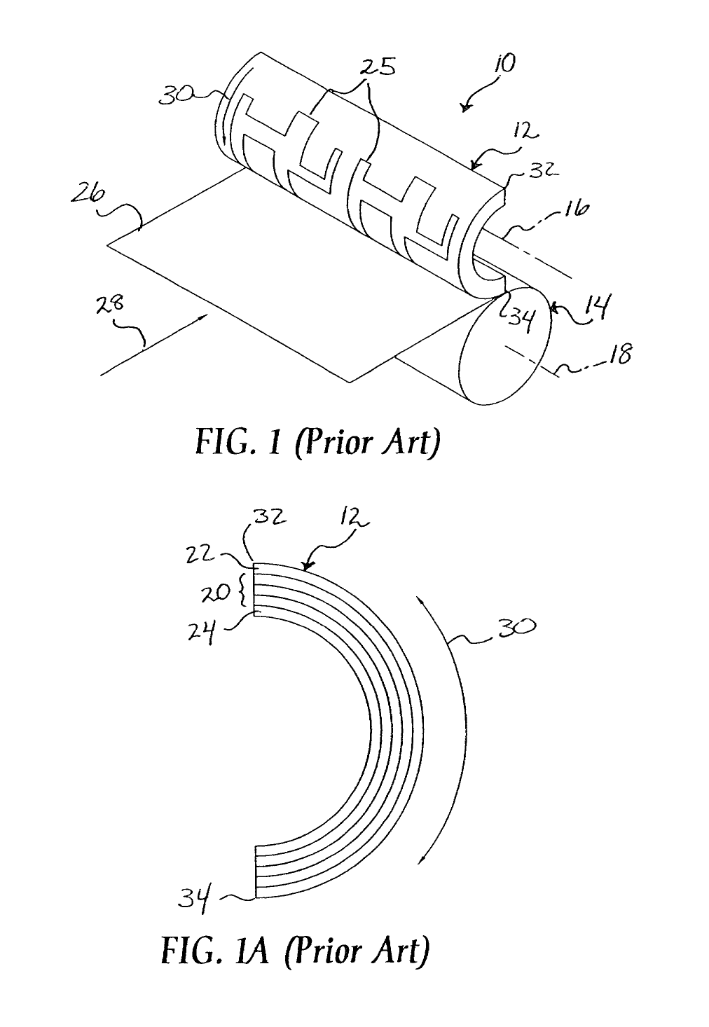

It is noted that the drawings are not necessarily to scale and are intended to portray only schematic representations of the invention. The invention will now be described with additional specificity and detail through the accompanying drawings, wherein like elements are represented throughout the drawings by like numerals.

### DETAILED DESCRIPTION OF THE PREFERRED EMBODIMENTS

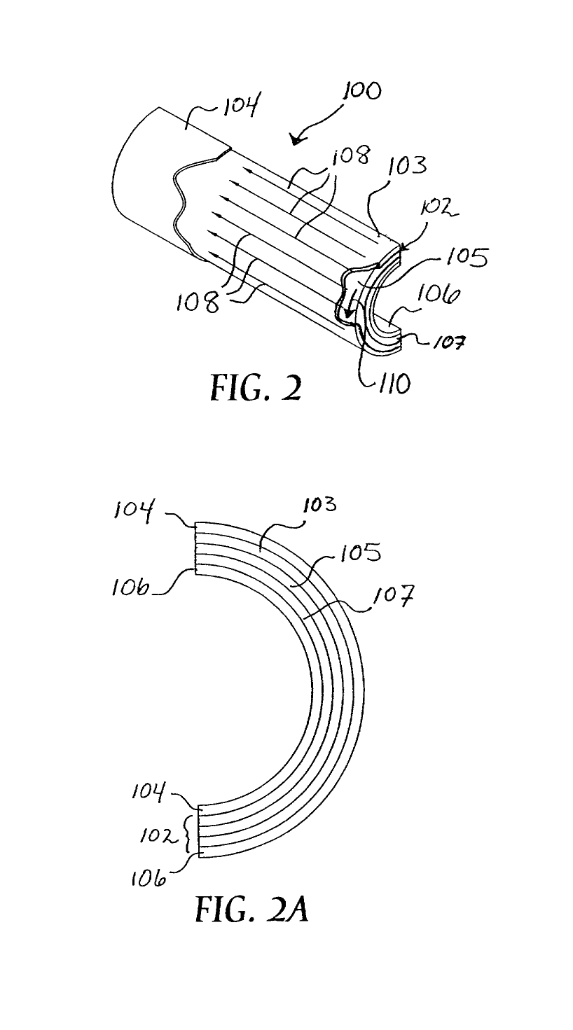

Referring now to the drawings, and to FIGS. 2 and 2A in particular, a dieboard 100 according to the present invention for use with a diecutting machine is illustrated. As shown, the dieboard 100 is semi-cylindrical in shape, but may be flat or of some other shape depending on the type of diecutting machine used. The dieboard 100 includes a core 102 comprising a plurality of intermediate layers 103, 105 and 107, a face layer 104, and a backing layer 106. Although three core layers are shown, it is to be understood that more or less core layers may be provided depending on the specified thickness of the final dieboard product and other factors. The core layers 103, 105 and 107 are preferably constructed of wood veneers such as maple (soft or hard), sweet gum or other wood species. The core layers may alternatively be constructed of a combination of wood species to produce a product that is termed a “mixed core” laminate in the industry.

The face layer 104 and backing layer 106 are preferably constructed of a synthetic veneer having a relatively smooth surface that is substantially free of defects. A suitable veneer is known as Gator-Ply® and is supplied by International Paper, Decorative Products Division, of Statesville, N.C. This veneer comprises a pulp paper product impregnated with a urea-formaldehyde based polymeric resin. The use of this veneer for a backing layer in laminated furniture and the like articles has been suggested. However, it has never been used as a face layer due to its relatively unattractive appearance, and has never been used as any layer in the diecutting industry since maple and other high quality natural wood veneers are exclusively used.

Construction of the dieboard 100 according to an exemplary embodiment of the invention includes laying down the face layer 104 comprising the paper pulp product. The core layer 103 comprising maple or other wood product is coated on both sides with a suitable glue that is compatible with the materials of the face layer 104 and core layer 103. The glue may be applied in a well known manner by passing the core layer 103 through a double roller glue spreader to spread a specified amount of glue lines on both surfaces of the core layer 103. The core layer 103 is then placed over the face layer 104 with the grain direction (represented by arrows 108) of the core layer 103 extending substantially parallel to a longitudinal axis of the dieboard. The face layer 104 is shown in FIG. 2 as partially cut away in order to show the grain direction 108 of the core layer 103.

Glue is then applied to the core layer 105 in a similar manner and the core layer 105 is then placed over the core layer 103. Preferably, the grain direction of the core layer 105, as represented by arrow 110, extends substantially transverse to the grain direction 108 of the core layer 103. Alternating grain directions in this manner strengthens the final dieboard product and reduces defects that may occur during the lamination process.

The core layer 107 is then placed over the core layer 105 in a similar manner with the grain direction substantially parallel to the grain direction 108. Other core layers may be applied in a similar manner until the specified thickness is reached. The backing layer 106 is then placed over the final core layer 107.

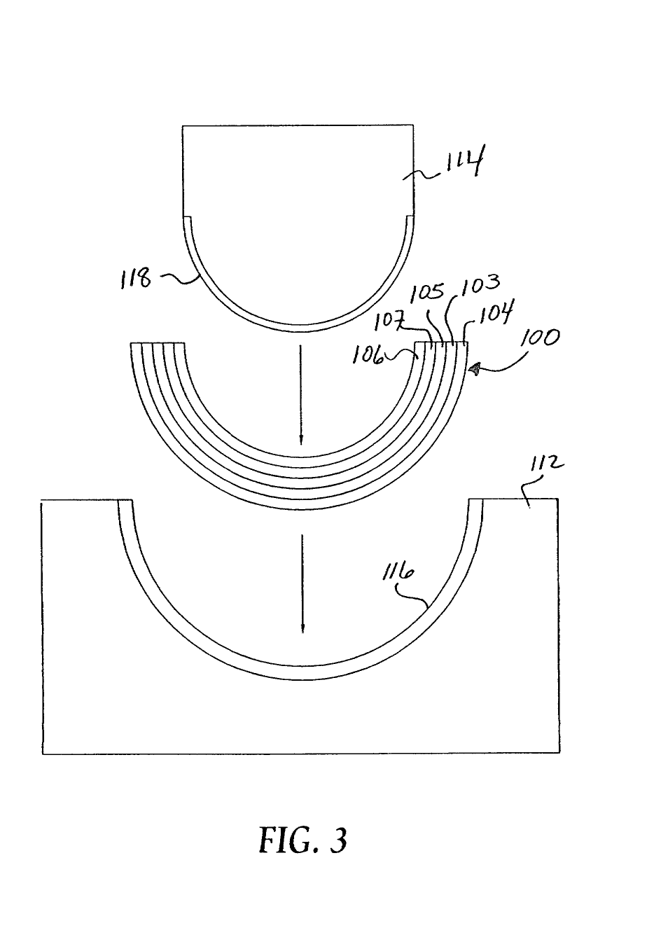

With further reference to FIG. 3, the uncured laminate is preferably positioned and pressed between a female die portion 112 and a male die portion 114 of a mold to form the laminate into the desired shape. Preferably, the die portion 112 has an inner conductive surface 116 with a diameter that is substantially equal to the final outside diameter of the dieboard 100, while the die portion 114 has an outer conductive surface 118 with an outer diameter that is substantially equal to the final inside diameter of the dieboard. The conductive surfaces preferably form part of a radio frequency curing circuit that applies microwaves to the laminate for curing the layers of glue between the veneer layers in a well-known manner. After curing, the dieboard 100 is cooled for a predetermined period of time in the mold and then trimmed to the specified dimensions.

A final finishing process includes verifying dieboard thickness, internal diameter, soundness, squareness, and straightness of lead edges. Defects in the surface, if any, can then be filled and sanded smooth. Once finished, slits may be cut in the dieboard with a laser or other cutting tool so that cutting blades, perforation blades, creasing blades, and other elements can be installed in the slits. It has been found that the resin-impregnated pulp paper product is especially suitable for laser cutting, since the edges of the slits are smooth and free of charring when combined with the core layers.

The use of a resin-impregnated pulp paper product as the face and backing layers in dieboards is a vast improvement over the prior art. Such a product eliminates the need for top grade maple facing, which is currently the industry standard, to thereby reduce the overall material cost of the dieboards. Manufacturing and labor costs associated with the dieboards are also reduced by using the pulp paper product, especially when the grain direction adjacent the face and backing layers extend substantially parallel to the longitudinal axis of the dieboard. Accordingly, the number of rejects and the labor associated with repairing unacceptable veneer faces and backing, such as delamination, splits, splicing, knotholes, twisting, bowing, and so on, when compared with the prior art is substantially reduced or eliminated. The pulp paper product is also more resistant to moisture penetration than prior art dieboards, and therefore may be used in high-moisture applications. More consistent and controlled thickness of the dieboard is also afforded by the pulp paper product.

While the invention has been taught with specific reference to the above-described embodiments, those skilled in the art will recognize that changes can be made in form and detail without departing from the spirit and the scope of the invention. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A dieboard for use in diecutting machinery, the dieboard comprising:
a face layer constructed of a resin-impregnated pulp paper sheet material;
a backing layer constructed of one of a natural wood veneer and a resin-impregnated pulp paper sheet material; and
a first core layer constructed of a natural wood veneer, the first core layer being interposed between the face layer and the backing layer.

2. A dieboard according to claim 1, wherein the backing layer is constructed of the resin-impregnated pulp paper sheet material.

3. A dieboard according to claim 2, wherein the dieboard is semi-cylindrical in shape.

4. A dieboard according to claim 2, wherein a grain direction of the first core layer is substantially parallel to a longitudinal axis of the semi-cylindrical dieboard.

5. A dieboard according to claim 4, and further comprising a second core layer interposed between the first core layer and the backing layer, the second core layer being constructed of a natural wood veneer.

6. A dieboard according to claim 5, wherein a grain direction of the second core layer is substantially parallel to the longitudinal axis of the semi-cylindrical dieboard.

7. A dieboard according to claim 6, and further comprising a third core layer interposed between the first and second core layers.

8. A dieboard according to claim 7, wherein a grain direction of the third core layer is substantially perpendicular to the grain direction of the first and second core layers.

9. A method of forming a dieboard for use in diecutting machinery, the method comprising:
providing a face layer constructed of a resin-impregnated pulp paper sheet material;
providing a backing layer constructed of one of a natural wood veneer and a resin-impregnated pulp paper sheet material;
providing a first core layer constructed of a natural wood veneer; and
laminating the first core layer between the face layer and the backing layer.

10. A method according to claim 9, wherein the backing layer is constructed of the resin-impregnated pulp paper sheet material.

11. A method according to claim 9, and further comprising forming the dieboard into a semi-cylindrical shape.

12. A method according to claim 11, and further comprising orienting a grain direction of the first core layer substantially parallel to a longitudinal axis of the semi-cylindrical dieboard prior to laminating the layers together.

13. A method according to claim 12, and further comprising interposing a second core layer between the first core layer and the backing layer prior to laminating the layers together, the second core layer being constructed of a natural wood veneer.

14. A method according to claim 13, and further comprising orienting a grain direction of the second core layer substantially parallel to the longitudinal axis of the semi-cylindrical dieboard prior to laminating the layers together.

15. A method according to claim 14, and further comprising interposing a third core layer between the first and second core layers prior to laminating the layers together.

16. A method according to claim 15, and further comprising orienting a grain direction of the third core layer substantially perpendicular to the grain direction of the first and second core layers prior to laminating the layers together.
